(19) United States
(12) Patent Application Publication
(10) Pub. No.: US 2007/0271453 A1
(43) Pub. Date: Nov. 22, 2007

(54) Identity based flow control of IP traffic

(75) Inventors: Seppo Pohja, Tampere (FI); Jarno Leinonen, Lempaala (FI); Kari Oinonen, Lempaala (FI); Juha Hietasarka, Suinula (FI); Petri Nykanen, Nokia (FI); Jari Mononen, Ruutana (FI); Ulla Konkarikoski, Tampere (FI); Jyrki Valli, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nikia Corporation

(21) Appl. No.: 11/699,471

(22) Filed: Jan. 30, 2007

(30) Foreign Application Priority Data
May 19, 2006 (EP) 06114280.8

(51) Int. Cl. H04L 9/00

(52) U.S. Cl. 713/153

(57) ABSTRACT

Authentication information of a first node is received which are used for verification of remote nodes' authentication attempts, and a token is received from at least one remote node. Authentication of the at least one remote node is performed based on the token, and, if the authentication is successful, rules of a firewall are set through which all communication towards a first node goes to accept packets from an address of the remote node to the address of the first node.

### BACKGROUND OF THE INVENTION

1. Field of the Invention

The present invention relates to a communication network for providing seamless peer-to-peer connectivity between nodes of different communication network environments.

In particular, the invention relates to traffic control in the communication network.

2. Description of the Related Art

A problem for devices is that when offering device-based services for remote users, these may cause too much bandwidth or service usage in general.

Core internet protocols include various flow control mechanisms where a host (i.e. a node) can affect the amount of IP packets it receives from other nodes. The ICMP (Internet Control Message Protocol) is one of the core Internet Protocols. It allows a node to send a control message to another node to slow down the rate of sending IP (Internet Protocol) packets.

According to the prior art it is possible to assign bandwidth quotas based on various criteria—e.g. based on the IP address—of the other node. However, there is no sufficient data available to apply criteria based on the identity of the person operating the other node or the identity of the node itself. The identity of the node can often be deduced from the IP address or—if available—the reverse DNS (Domain Name Server) lookup, but this is a low security solution which can easily be spoofed.

Firewalls can, in principle, be used to provide a very crude form of flow control where the protected node reconfigures the firewall to cut of traffic from the third party. The protected node may or may not have required the third party to identify. This approach simply shuts down the flow rather than regulates it.

There are also many other Internet Protocols that implement forms of flow control. There are QoS (Quality of Service) mechanisms for sharing bandwidth so that critical applications (like real time video) get the bandwidth they need. Also fairness mechanisms are known to guarantee that one user does not steal all the bandwidth when sharing an IP connection, but this is generally implemented based on MAC (Medium Access Control) address. These protocols can be used for flow control per service (per port) as ICMP only supports IP address level flow control.

The US 2005/0 141 535 discloses a method and apparatus to handle parity errors in flow control channels. A network processor is provided having a flow control message First In First Out (FIFO) buffer which includes a parity field. The network processor is included as either or both of an Ingress network processor and an Egress network processor and is used within a CSIX system or an NPSI NPE system.

The US/2005 0 259 575 discloses a method for dynamic flow control which includes accepting incoming data into a shared resource during a first time period after transmitting a flow control message, and diverting incoming data from the shared resource during a second time period that is after the first time period.

### SUMMARY OF THE INVENTION

The present invention has been devised to overcome the above problems. The invention presents a way to limit service usage and balance resources between users, without totally blocking them.

FIG. 3 shows a schematic block diagram illustrating a firewall managing server 100, a remote node 200 and a node hosting service(s) 300 according to an embodiment of the invention. It is to be noted that the firewall managing server and the nodes shown in FIG. 3 may have further functionality for working as network nodes. Here the functions of the entities relevant for understanding the principles of the invention are described using functional blocks as shown in FIG. 3. The arrangement of the functional blocks of the entities is not construed to limit the invention, and the functions may be performed by one block or further split into sub-blocks.

According to an aspect of the invention, referring to FIG. 3, a firewall managing server 100 is provided comprising:

a receiving unit 11 configured to receive authentication information of a first node used for verification of remote nodes' authentication attempts, and to receive a token from at least one remote node such as the remote node 200, for example;

an authentication unit 12 configured to perform authentication of the at least one remote node based on the token; and

a setting unit 13 configured to, if the authentication is successful, set rules of a firewall through which all communication towards a first node goes to accept packets from an address of the remote node to the address of the first node.

The authentication information may comprise cryptographic code or a shared secret such as an access code.

The authentication information may comprise public keys.

The authentication may comprises an authentication challenge presented to the at least one remote node.

The authentication may comprise checking that a shared secret provided comprised in the authentication information is valid.

The authentication unit 12 may hold an address of the remote node.

The firewall managing server 100 may further comprise a monitoring unit 14 configured to monitor an amount of traffic through the firewall caused by the remote node and to output a message for controlling the amount of traffic in accordance with traffic restriction requirements defined for the remote node.

Thus, a firewall node such as the firewall managing server 100 stores the traffic restriction requirements and sends the flow control messages independently of a server node such as the node 300 shown in FIG. 3.

The receiving unit 11 may receive the traffic restriction requirements for the remote node.

The monitoring unit 14 may send the message to at least one remote node.

At least some of the features of the firewall managing server 100 may be implemented as software in a firewall node, or may be implemented in a separate node connected to the firewall node.

Moreover, according to an aspect of the invention, the node 300 comprises:

a providing unit 31 configured to provide a ticket to a remote node of a communication network, such as the remote node 200, for example, the ticket authenticating the remote node to access the node through a firewall node.

The ticket may be valid for a limited period of time.

The node 300 may comprise a generating unit 32 configured to generate public keys used for verification of remote host authentication attempts; and

a sending unit 33 configured to provide the public keys to a firewall managing server such as the firewall managing server 100.

The node 300 may further comprise a traffic control unit 34 configured to send traffic restriction requirements to the firewall managing server for remote nodes.

Furthermore, according to an aspect of the invention, the node 200 comprises:

an authentication unit 21 configured to perform authentication at a firewall of a first node;

a sending unit 22 configured to, if the authentication is successful, send packets from an address of the node to an address of the first node through the firewall; and

a traffic control unit 23 configured to receive a message for controlling an amount of traffic towards the first node.

The traffic control unit 23 may control the traffic towards the first node based on the message.

For the purpose of the present invention to be described herein below, it should be noted that

a communication device may for example be any device by means of which a user may access a communication network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals are particularly suitable for being used in connection with the present invention;

a communication device can act as a client entity or as a server entity in terms of the present invention, or may even have both functionalities integrated therein;

method steps likely to be implemented as software code portions and being run using a processor at one of the server/client entities are software code independent and can be specified using any known or future developed programming language;

method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices can be implemented as individual devices, but this does not exclude that they are implemented in a distributed fashion throughout the system, as long as the functionality of the device is preserved.

The invention solves the problem of how to assign and apply bandwidth quotas to third parties accessing an Internet node.

According to the invention, a terminal with continuous connectivity to an overlay network such as, for example, an IPv6 (Internet Protocol version 6) overlay network, can protect itself from unwanted traffic, which the subscriber might have to pay for or which in other ways is undesirable, for example by draining the battery of a mobile terminal.

In an embodiment of the invention, a firewall located before the air interface (which may be subject to charge) is configured to require credentials from nodes wishing to send packets to a terminal. The credentials may be sent out-of-band (OOB) beforehand and can take the form of either access codes, or public-key information, that identify the remote node and allow it preconfigured types of access. The access parameters can be configured on port/application basis.

According to the invention, identities of third parties can be used as a basis of bandwidth quota policy. As quota works on IP level, this can easily be applied to all applications and services, without need to implement case specific mechanisms.

### BRIEF DESCRIPTION OF THE DRAWINGS

FIG. 1 shows a schematic diagram illustrating a connection of another client to a client behind a firewall according to the invention.

FIG. 2 shows a signaling diagram illustrating signaling between a firewall and nodes according to an embodiment of the invention.

FIG. 3 shows a schematic block diagram illustrating a firewall managing server and nodes according to an embodiment of the invention.

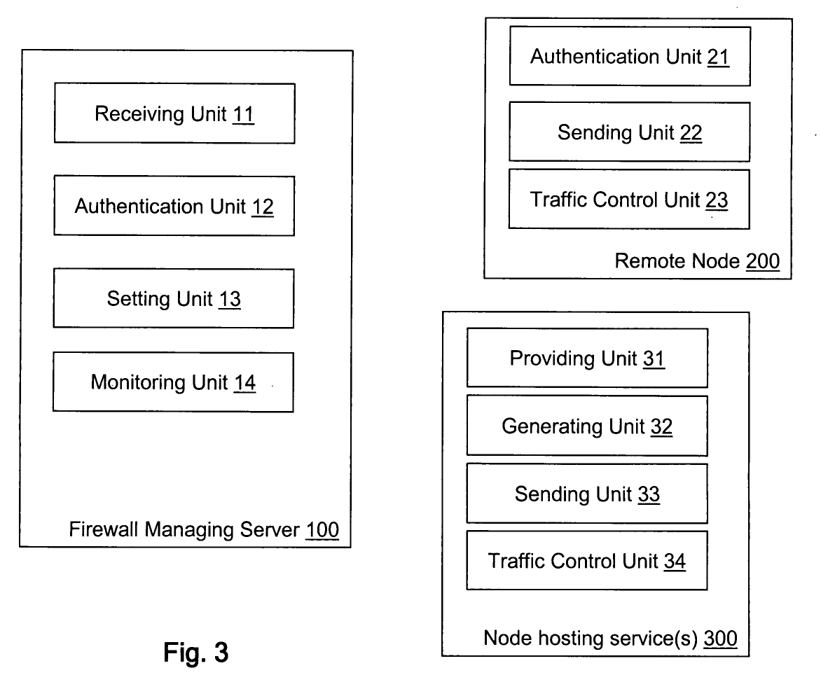

### DESCRIPTION OF THE PREFERRED EMBODIMENTS

According to the present invention the nodes will become addressable in an overlay network. In embodiments of the invention, the nodes have IPv6 address in the overlay network thus avoiding the limitations of the IPv4 address space.

### Addressability

Internet nodes that are behind NATs (Network Address Translators) or NAPTs (Network Address and Port Translators) and/or firewalls typically have grey IP address that is usually dynamically allocated (through DHCP (Dynamic Host Configuration Protocol)). The grey IP address is not routable in the Internet, and it would not make sense to map a hostname to such IP address. Usually such nodes are only able to initiate connections as Party A (originating party) to Internet nodes (located on the other side of the NAT/NAPT/Firewall).

In specific configurations dynamic DNS server in Internet can be utilized to first determine the currently valid IP address of the node (as it is visible in the Internet), and then to associate this IP address to hostname. The dynamic DNS server will then serve this information in the Internet Name server network. Depending on the network configuration between the node and the Internet (especially NAT/NAPT/Firewall) just by making the association (hostname, IP address) is not enough for truly communicating with the node from Internet.

The combination of dynamic DNS with tunneling enables the terminal to have IP address that stays valid, and it handles NAT, NAPT and firewall traversal issues.

### Reachability

As with addressability, Internet nodes that are behind NATs or NAPTs and/or firewalls typically have grey IP address that is usually dynamically allocated (through DHCP). The grey IP address is not routable in the Internet, and it would not make sense to map a hostname to such IP address. Usually such nodes are only able to initiate connections as Party A (originating party) to Internet nodes (located on the other side of the NAT/NAPT/Firewall).

It is possible to utilize known tunneling technologies (like IPSec, PPTP (Point-to-Point Tunnelling Protocol), Teredo) that tunnel all communication in and out of the node through a tunneling server (or all the way end-to-end). When initiating tunneling connection from node (e.g. mobile terminal) towards Internet, the NAT/NAPT/Firewall traversal problems can be mitigated. The networks where the nodes like mobile terminals are, usually allow communication towards Internet to be initiated, but they block communication from Internet towards the nodes in these networks (due to security or charging issues).

Furthermore, the tunneling protocols may contain functions such as heartbeat that will keep alive the connection from the node to the tunneling server in the Internet. They may also contain functions to identify if communication can be initiated directly between two nodes, bypassing need for tunneling server supported communication between those nodes.

In embodiments of the invention the tunneling protocols are used to connect all nodes to an overlay network where each terminal is assigned an IP address that is reachable in that network by other nodes of the same network. The overlay network is another network set up on top of multiple networks (i.e., the Internet).

Utilizing any one or two of IPv6 addresses for mobile terminals, providing (dynamic) DNS entries, or implementing tunneling may not solve addressing and reachability problem of mobile terminals (or home PCs or set top boxes).

It has been found that the combination of the three in the following manner can solve the stated problems in a way that is independent of the network configuration of the network the node is currently in:

An overlay network is defined. This overlay network is a network built on top of the current IPv4 network, and it is IPv6 based.

Nodes that are behind NAT/NAPT/Firewalls initiate themselves connection to tunneling server that provides access to the IPv6 overlay network. Multiple tunneling technologies can be utilized and some tunneling servers may support only one or all of the tunneling technologies utilized. Heartbeat function for created tunnel might be used to keep the tunnel open, when required.

Tunneling server assigns the node an IPv6 address that is routable in the overlay network. The tunneling server stores at runtime the association between the nodes “real address”, i.e., the IPv4 Internet address and the current IPv6 address. Thus it is capable of routing packets with IPv6 address through tunnel to the corresponding node.

Nodes update their (or alternatively the tunneling server does this on their behalf) overlay network address to dynamic IPv6 DNS server available to other nodes in the overlay network.

The result is that all nodes connected to the overlay network can request with hostname the current IPv6 address of another node connected to the overlay network. The (hostname, IPv6 address) pair is kept valid as the information is updated to the dynamic DNS server always the IPv6 address changes.

Because the IPv6 address of the node is assigned by the tunneling server (one function of “Proxy server” described below), the IPv6 packets in the overlay network will be routed to this tunneling server based on known Internet technologies. Furthermore, as the tunneling server knows the IPv4 addresses from each of the nodes connected to it, it can route the IPv6 packets correctly to the tunneling clients it has.

To solve the addressing and reachability of the mobile terminals (and home appliances), in Internet a stack of the mobile terminal capability to tunnel communication through an overlay network is implemented, and this capability is provided to applications. An overlay network is created in Internet where terminal registers. (Various) operators are enabled to take part into operating the overlay network. First applications are created to utilize the solution and that accumulate value to the terminal, (e.g., implementing web server to terminals, with sufficient access control to limit cost implications).

An overlay network is a virtual network built over one or more physical networks. The Internet is itself an example of an overlay network. In overlay networks the individual links that connect nodes can comprise multiple routers and hosts. The chosen architectural approach is based on overlay proxy servers where the clients of the overlay network register to get addressing, reachability and packet filtering services. The packet routing, which is based on known Internet technologies, takes place between the proxy servers. Enhancements to proxy based overlay architecture enable clients to communicate directly with each other in specific cases (i.e., packets routable directly between clients).

The present invention combines technology blocks such as firewall, tickets (or vouchers or shared secret) in a way that the combination may provide more value than the technology blocks each alone.

In the following it is described how firewall(s) and tickets/shared secret exchanged between nodes (parties A and B) can be used to weed out unwanted incoming traffic before it causes costs to the receiving party (especially in case of cellular packet network where the receiving party pays for incoming traffic).

If packets are routable for example to a mobile terminal, the receiving party may have to pay for the incoming traffic. However, the network does not provide any means to allow or block incoming traffic based on party sending the packets or the application (port) for which the packet is intended. If mobile terminals become addressable and reachable by other nodes in the Internet (or on an overlay network set up on top of the Internet), unless the network and client software implementations are under strong control, it is not possible to keep nodes either from sending packets to any node in the network (not knowing the receiver) or to keep nodes from targeting specific hostname. Thus, filtering out of incoming packets is an issue.

As mentioned above, the invention is to combine technologies of firewall (network side and in special case, on the node itself), and tickets (based on vouchers and/or shared secret between the nodes). The invention does not require a “Managed” or safe underlying network. The trust relations needed are only between the node and the entity in network handling the firewall function, and between the nodes that have either exchanged the shared secret, or otherwise generated a ticket that enables the other specific node to make firewall traversal when connecting the node.

As described above, a node has joined the overlay network, and established tunneling connection with a tunneling server (function) of a proxy server. The proxy server contains two new functionalities, firewall and firewall authorization/authentication server. Here, the authorization/authentication server is called firewall managing server.

The firewall is programmed by default to block all incoming traffic towards the node (it may also by default block all communication from the node until the node has provided it credentials, this is optional).

In general, the firewall may as well be a firewall on the administrative boundary of a company, and have nothing to do with the connectivity network.

Authorization where Party B gives (directly or indirectly through a third party) rights to Party A may be based on multitude of approaches. One general approach is to utilize a shared secret where both nodes know something nobody else does, and by checking credentials sent by the other party the authorization is given.

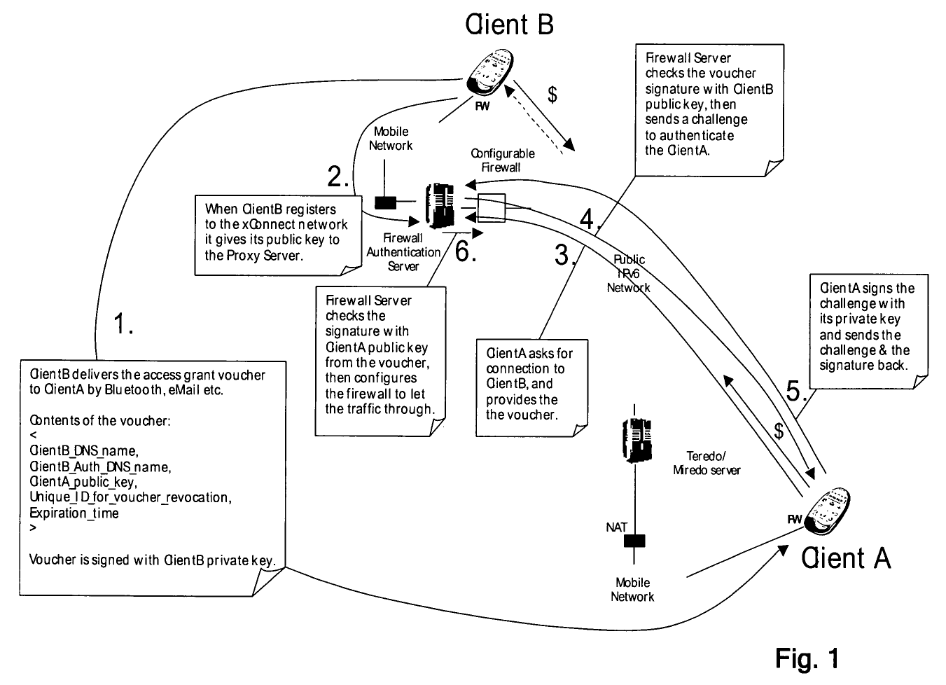

Another approach is to use public key cryptography in a way that Party B provides party A a signed ticket, and this ticket is checked against Party B's public key when Party A needs to be authorized, as shown in FIG. 1.

For example, as shown in FIG. 1, in communication 1. Client B delivers an access grant voucher to Client A by Bluetooth, eMail, or the like. In communication 2., when Client B registers to the network it gives its public key to the Proxy Server. In communication 3., Client A asks for connection to Client B and provides the voucher. In communication 4., the firewall managing server checks the voucher signature with Client B public key, and then sends a challenge to authenticate the Client A. In communication 5., Client A signs the challenge with its private key and sends the challenge and the signature back to the firewall managing server. In communication 6., the firewall managing server checks the signature with Client A public key from the voucher, and then configures the firewall to let the traffic through.

The ticket is based on certificates that identify a user (or a device). The Certificate is trusted by out of band means by the issuer of the ticket.

The Ticket typically includes parameters such as

Hostname of Service Provider

URL of Service Provider authorization server

Certificate of Service Provider (original issuer, optional)

Certificate of consumer

Validity period

Forwarding rules (e.g. how many steps are allowed)

Signature of ticket issuer (over the complete ticket)

Unique ticket identity

The Certificate may be issued by a Certificate Authority, or it may be self-signed. The level of trust defines the usage space and conventions. In many cases, especially in peer to peer applications, it is enough that the issuer of the ticket knows that the intended consumer is in possession of the certificate, and trust the consumer to keep the associated private key secret.

The ticket can be defined to be valid for a dedicated consumer only, or it can be defined to allow for forwarding. The forwarding allows for delegation of ticket distribution. When a ticket is forwarded the original ticket is appended with the certificate of the new consumer, and this new ticket is singed by the private key of the forwarding consumer. This mechanism creates a forwarding trail in the ticket that can be evaluated by the Service Provider when the ticket is used for service authorization.

The ticket is signed by the issuer, and thus an atomic unit. It includes the absolute expiry time relative to the Service Providers clock. Thus, if a ticket is forwarded it still expires at the exact time defined in the original ticket.

The ticket distribution can be executed in several different contexts, for example by means of messaging (email), online transaction, or in proximity environments (like Bluetooth or Infrared).

The service provider may at any time revoke tickets. This can be done either by revoking a specific ticket, or by revoking all the tickets that are issued to a specific certificate. Both of these revocation methods make it possible to revoke specific tickets, or chains of tickets created by forwarding.

There are situations, for example online ticket distribution, where the consumer does not yet have a ticket. It is then possible to out of band deliver a shared secret, such as a PIN code, to the consumer, and temporarily configure the firewall managing server to accept this particular shared secret.

In an environment such as the connectivity network described above, utilizing only a firewall with (semi) static rules for filtering unwanted incoming packets is not appropriate. There may be specific cases where access should be provided from home PC or some other system in the Internet to access always the mobile phone, but even in those cases the IP address may change, and a hostname would be more preferably identified. However, this would lead to gethostbyname type of queries by the firewall affecting its scalability greatly.

Utilizing only authorization end-to-end between nodes may not enable filtering unwanted packets before they enter the radio interface, incurring costs to the receiving party.

It is the combination presented by the invention that can solve the stated problems:

A firewall is placed in the network. All overlay communication towards node (Party B) goes through this firewall. The firewall may be optimized to handle the following type of rules: 128-bit IPv6 source address, 128-bit IPv6 destination address, drop or forward, and validity period for forwarding.

A logical entity called Firewall managing server is placed in the network. This entity may have two functions, verification/authentication server and authorization server. The firewall managing server may be part of the firewall. In an alternative, it is a separate entity as this may enable better scalability of the firewall.

As shown in communication 1. in FIG. 1, Party B has provided party A “a ticket” that authorizes Party A to access it through the firewall managing server. The ticket related information comprise:
Hostname of the Party B
Hostname of the authorization server Party B utilizes (could be fixed, but preferably hostname based)
Ticket credentials (shared secret or preferably public key based approach)
Ticket validity period (should be long to avoid unnecessary traffic, but for special cases like Party A only “visiting for a day” can be set for short time period).

Party B keeps its own hostname, and the hostname of the Firewall managing server always up-to-date when it is connected to the overlay network. The overlay network configuration has provided it address pair of proxy (tunneling) server and firewall managing server. Party B may set the hostname of the Firewall managing server to invalid address 0000:0000: . . . if it does not require authorization—thus indicating to any connecting party that the authorization process can be terminated.

Party B provides to the authorization server function of firewall managing server its public key(s) used for verification of the remote host authorization attempts (cf. communication 2. in FIG. 1). In an alternative, the public key (or shared secret) is stored into the firewall managing server.

As shown in communication 3. in FIG. 1, when Party A wants to initiate communication with Party B, it needs first to send the ticket it received from party B to the firewall managing server (the currently valid firewall managing server address is found by having its hostname in the ticket, and at runtime Party B updates the DNS information where this hostname points to. In an alternative, the hostname may be static.

When the authorization server function of the Party B's FW managing server receives over a connection the ticket from A, it will make authorization challenge to Party A. This may be done to ensure that Party A is really the party A that the ticket was generated for (cf. communications 4, 5 in FIG. 1).

If authorization challenge is successful, the FW managing server will set firewall rule to accept packets from the Party A's IPv6 address to Party B's IPv6 address (cf. communication 6 in FIG. 1). A validity period can be set.

The result is that only those nodes that have Party A's IPv6 address or which can successfully spoof source address, can send packets over the radio interface to party B.

Because a secure end-to-end connection (based on SSL, IPSEC, or other technology) is not provided, this provided level of security is only used for filtering unwanted packets.

If during the handshake between Party A and the Firewall managing server additional credentials are created, these can easily be used to set up secure end-to-end connection if needed.

In the following an enhancement of the invention will be described.

Considering a case where a terminal (Party B) is connected through access that does not have incoming traffic implications, it can set the address of its hostname for firewall managing server to invalid address. This would effectively give possibility to any node (Party A) to send packets to this node, which may not be desirable.

Another approach is to implement in the Party B:

Local Firewall that can be controlled similarly as the above-described firewall in the network, i.e., with the setting of firewall rules for dropping or forwarding packets.

Local Firewall managing server.

Party B updates the hostname in the dynamic DNS server to point to its current IPv6 address (i.e., the hostname of Party B's node and the firewall managing server hostname both point to the IPv6 address currently valid for Party B node).

Unless Party A has got authorization from the local Firewall managing server of Party B, the local firewall in Party B's node will not forward packets from Party A's IPv6 address to any of the applications. This provides IPv6 address granularity for the Party B to weed out unwanted packets, and to base the approach on the same ticket paradigm as with the “network supported” case described above.

This may not solve the filtering of incoming packets before they enter the radio interface of Party B. However, it may still provide value by limiting what parties can send packets to Party B even if it is connected over link where there is no cost implications for incoming packets (for example, to limit strain on batteries).

Another enhancement of the invention is for Party B to generate more than one type of tickets that are provided to other parties, including Party A. The approach is similar to the enhancement case above. However, additional functions are needed in terminal of Party B as follows:

Generation of multiple concurrently valid tickets

Local association of ticket to applications that it enables, for example Visitor ticket only provides access to mobile web server to view my pictures of share folder.

Firewall with the rules of format:
IPv6 Source IP address
IPv6 Destination IP address
IPv6 Destination Port address
Block/forward
Validity
Firewall managing server which identifies the ticket category and can locally look up and open the ports that this ticket category is allowed to access.

In the following an embodiment of the invention will be described.

The embodiment provides enhancements or functionality in an overlay network client to help it function more effectively in the connectivity overlay network.

As described above, there are ways of using firewalls where the owner of the node protected by the firewall hands out credentials to other nodes. By presenting proper credentials, an external node can reconfigure the firewall so as to initiate IP-traffic with the protected node. A firewall in the context of the present application may also comprise functions not present in all firewalls, such as allowing a certain volume of flow from a defined IP address.

The same concept can be applied both to local (on the node itself) and remote (on a device upstream on the routing path) firewalls. Remote firewalls can be used as a cost-control mechanism—not just access control—if the cost of the Internet connection of the node increases with the increased IP-traffic.

For purposes of this invention, cases are considered where the credentials used by the external node to reconfigure firewall are such that they can be used to identify the party using the credentials. For example: The party is a member of a given group, the party is such and such node, the party is such and such person, the party is the same party as the one who last reconfigured the firewall 10 hours and 3 minutes ago.

According to the embodiment,

quota policies and parameters for third parties may be decided;

the third party may be required to identify itself in order to be able to initiate any IP-traffic to an own node (in practice, this means that there is a firewall in place);

notes may be taken as to which IP address(es) the third party is using;

the amount of traffic through the firewall caused by each third party (including traffic initiation by own node) may be monitored;

if the third party is causing too much traffic inbound, the firewall may be caused to send a flow control message to the node(s) of the third party in order to reduce the flow; and

if the third party is causing too much outbound traffic, the firewall may be caused to send the flow control message to the own node.

The quota policies can be quite simple, such as “Third party X can use Y bits per second”, or they can be quite complex taking into account the overall bandwidth being used at any given time or the bandwidth used by the third party over different periods of time, and the like.

If the invention is used with a policy containing long term restrictions, e.g. bits per one month, the decisions about sending the control messages should use some more complex logic than simple thresholding of the number of bits. Differential, integrating and derivative controllers (so called PID controllers), rule based logic, artificial intelligence or fuzzy logic are some alternatives.

The application level control can be based on the IP port numbers or there can be some other system to match connections to different applications.

The ICMP protocol is a simple way to control all IP traffic. Other protocols, if supported and understood by the firewall, can be used as well. The other protocols may have limited effect e.g. because they are dealing with audio stream only or file transfer only.

### More Examples of Quota Policies

Used bearer type can also influence the currently applied quota policy: cost, power consumption etc.

Current resource consumption situation can also influence applied quota: for example, how much a user utilizes device resources for applications serving herself/himself, and how much she/he can afford to be used to serve remote users.

In an addition to the control of traffic on the node level, the invention can be used to control traffic on the application level. For example, better quota policies can be configured for one application than another. Then the traffic for one application could not be limited even if the traffic for another application is already started to be limited. This application level control may be or may not be connected to the node identities. Then it is possible to have the same application quota policies for all the nodes or have the node identity based control on applications.

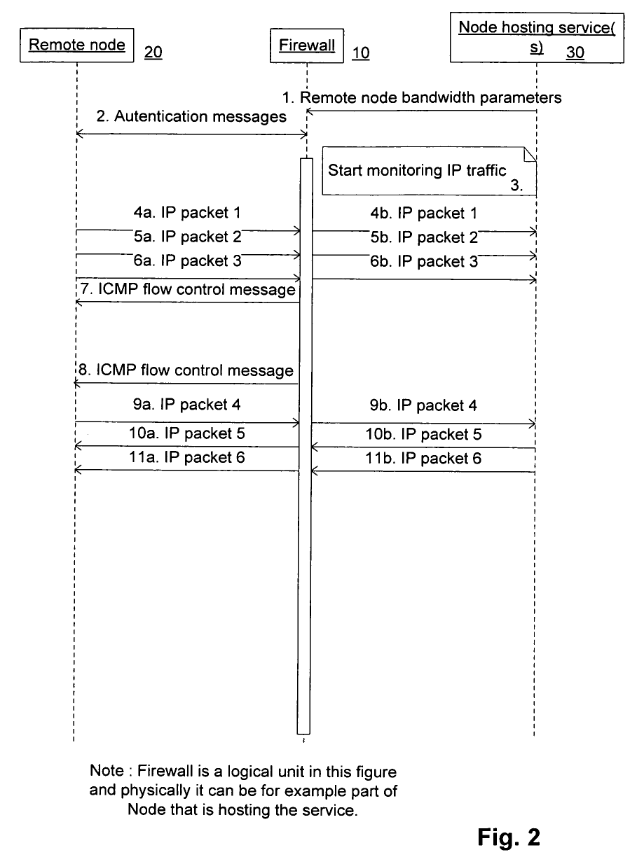

FIG. 2 shows a signaling diagram illustrating signaling between a firewall managing server which is simply referred to as firewall 10 in the following, and a remote node 20 and between the firewall 10 and a node 30 hosting a service or services according to the embodiment of the invention.

The node 30 hosting the service(s), referred to as serving node in the following, decides quota policies and parameters for third parties, including e.g. bandwidth parameters for the remote node 20. In communication 1 in FIG. 2, the serving node 30 sends the remote node bandwidth parameters to the firewall 10. It is to be noted that the firewall is a logical unit in FIG. 2 and physically can be e.g. part of the serving node 30.

The remote node 20 is required to identify itself at the firewall 10 to be able to initiate any IP traffic to the serving node 30 (communication 2. in FIG. 2: Authentication message/ticket). The authorization/authentication procedure as described above with respect to FIG. 1 may be applied. In that case, Client B in FIG. 1 corresponds to the serving node 30 and Client A in FIG. 1 corresponds to the remote node 20.

The firewall 10 makes notes which IP address(es) the remote node 20 is using and starts monitoring the IP traffic caused by the remote node 20 (process 3. in FIG. 2).

In communications 4a., 4b., to 6a., 6b, the remote node 20 sends IP packets 1 to 3 to the serving node 30 through the firewall 10.

According to traffic restrictions for the remote node 20, after having received the third IP packet the firewall 10 may send a flow control message to the remote node 20 in order to reduce the flow (communication 7. in FIG. 2: ICMP flow control message). This causes the remote node 20 to stop sending IP packets to the serving node 30.

Then, after a while, again in accordance with the traffic restrictions for the remote node 20, the firewall 10 sends a further flow control message to the remote node 20 (communication 8. in FIG. 2), which indicates that the remote node 20 is allowed to send further IP packets.

Thereupon, the remote node 20 sends a further IP packet (IP packet 4, communications 9a., 9b. in FIG. 2) to the serving node 30 through the firewall 10.

Upon receiving the IP packets from the remote node 20, the serving node 30 starts to send IP packets 5, 6 to the remote node 20 through the firewall 10 (communications 10a., 10b., and 11a., 11b. in FIG. 2).

In the above example, merely three IP packets are allowed to be transmitted between the remote node 20 and the serving node 30 within a short time interval. However, this is only an example and other restriction policies are possible.

It is to be understood that the above description is illustrative of the invention and is not to be construed as limiting the invention. Various modifications and applications may occur to those skilled in the art without departing from the true spirit and scope of the invention as defined by the appended claims.

What is claimed is:

1. A firewall managing server comprising:
a receiving unit configured to receive authentication information of a first node used for verification of remote nodes' authentication attempts, and to receive a token from at least one remote node;
an authentication unit configured to perform authentication of the at least one remote node based on the token; and
a setting unit configured to, if the authentication is successful, set rules of a firewall through which all communication towards a first node goes to accept packets from an address of the remote node to the address of the first node.

2. The firewall managing server of claim 1, wherein the authentication information comprises public keys.

3. The firewall managing server of claim 1, wherein the authentication information comprises a shared secret.

4. The firewall managing server of claim 1, wherein the authentication comprises an authentication challenge presented to the at least one remote node.

5. The firewall managing server of claim 1, wherein the authentication comprises checking that a shared secret provided comprised in the authentication information is valid.

6. The firewall managing server of claim 1, wherein the authentication unit is configured to hold an address of the remote node.

7. The firewall managing server of claim 1, comprising
a monitoring unit configured to monitor an amount of traffic through the firewall caused by the remote node and to output a message for controlling the amount of traffic in accordance with traffic restriction requirements defined for the remote node.

8. The firewall managing server of claim 7, wherein the receiving unit is configured to receive the traffic restriction requirements for the remote node.

9. The firewall managing server of claim 7, wherein the monitoring unit is configured to send the message to at least one remote node.

10. A node comprising:
a providing unit configured to provide a ticket to a remote node of a communication network, the ticket authenticating the remote node to access the node through a firewall node.

11. The node of claim 10, wherein the ticket is valid for a limited period of time.

12. The node of claim 10, comprising:
a generating unit configured to generate public keys used for verification of remote host authentication attempts; and
a sending unit configured to provide the public keys to a firewall managing server.

13. The node of claim 10, comprising:
a traffic control unit configured to send traffic restriction requirements to a firewall managing server for remote nodes.

14. A node comprising:
an authentication unit configured to perform authentication of a second node at a firewall of a first node;
a sending unit configured to, if the authentication is successful, allow packets from an address of the second node to an address of the first node through the firewall; and
a traffic control unit configured to receive a message for controlling an amount of traffic towards the first node.

15. The node of claim 14, wherein the traffic control unit is configured to control the traffic towards the first node based on the message.

16. A firewall managing method comprising:
receiving authentication information of a first node used for verification of remote nodes' authentication attempts, and receiving a token from at least one remote node;
performing authentication of the at least one remote node based on the token; and
if the authentication is successful, setting rules of a firewall through which all communication towards a first node goes to accept packets from an address of the remote node to the address of the first node.

17. The firewall managing method of claim 16, wherein the authentication information comprises public keys.

18. The firewall managing method of claim 16, wherein the authentication information comprises a shared secret.

19. The firewall managing method of claim 16, wherein the authentication comprises an authentication challenge presented to the at least one remote node.

20. The firewall managing method of claim 16, wherein the authentication comprises checking that a shared secret provided comprised in the authentication information is valid.

21. The firewall managing method of claim 16, comprising holding an address of the remote node.

22. The firewall managing method of claim 16, comprising:
monitoring an amount of traffic through the firewall caused by the remote node and outputting a message for controlling the amount of traffic in accordance with traffic restriction requirements defined for the remote node.

23. The firewall managing method of claim 22, comprising receiving the traffic restriction requirements for the remote node.

24. The firewall managing method of claim 22, comprising sending the message to at least one remote node.

25. A method comprising:
providing a ticket to a remote node of a communication network, the ticket authenticating the remote node to access a node through a firewall node.

26. The method of claim 25, wherein the ticket is valid for a limited period of time.

27. The method of claim 25, comprising:
generating public keys used for verification of remote host authentication attempts; and
providing the public keys to a firewall managing server.

28. The method of claim 25, comprising:
sending traffic restriction requirements to a firewall managing server for remote nodes.

29. A method comprising:
performing authentication at a firewall of a first node;
if the authentication is successful, sending packets from an address of the node to an address of the first node through the firewall; and
receiving a message for controlling an amount of traffic towards the first node.

30. The method of claim 29, comprising controlling the traffic towards the first node based on the message.

31. A computer program comprising processor implementable instructions for performing all the steps of a method according to any one of claims 16 to 28.

32. A computer program comprising processor implementable instructions for performing all the steps of a method according to claim 29 or 30.

33. A computer software medium storing a computer program according to claim 31.

34. A computer software medium storing a computer program according to claim 32.

35. A computer program product loadable into a programmable processing device, comprising software code portions for performing the steps of the method according to any one of claims 16 to 28, when the computer program product is run on a programmable device.

36. A computer program product loadable into a programmable processing device, comprising software code portions for performing the steps of the method according to claim 29 or 30, when the computer program product is run on a programmable device.

37. A firewall managing server comprising:
means for receiving authentication information of a first node used for verification of remote nodes' authentication attempts, and for receiving a token from at least one remote node;
means for performing authentication of the at least one remote node based on the token; and
means for, if the authentication is successful, setting rules of a firewall through which all communication towards a first node goes to accept packets from an address of the remote node to the address of the first node.

38. A semiconductor chip comprising:
a receiving unit configured to receive authentication information of a first node used for verification of remote nodes' authentication attempts, and to receive a token from at least one remote node;
an authentication unit configured to perform authentication of the at least one remote node based on the token; and
a setting unit configured to, if the authentication is successful, set rules of a firewall through which all communication towards a first node goes to accept packets from an address of the remote node to the address of the first node.

39. A node comprising:
means for providing a ticket to a remote node of a communication network, the ticket authenticating the remote node to access the node through a firewall node.

40. A semiconductor chip comprising:
a providing unit configured to provide a ticket to a remote node of a communication network, the ticket authenticating the remote node to access the node through a firewall node.

41. A node comprising:
means for performing authentication at a firewall of a first node;
means for, if the authentication is successful, sending packets from an address of the node to an address of the first node through the firewall; and
means for receiving a message for controlling an amount of traffic towards the first node.

42. A semiconductor chip comprising:
an authentication unit configured to perform authentication at a firewall of a first node;
a sending unit configured to, if the authentication is successful, send packets from an address of the node to an address of the first node through the firewall; and
a traffic control unit configured to receive a message for controlling an amount of traffic towards the first node.
